(19) United States
(12) Patent Application Publication
(10) Pub. No.: US 2006/0147656 A1
(43) Pub. Date: Jul. 6, 2006

(54) Simulated coral rock and method of manufacture

(76) Inventor: Theodore J. Mathieu, West Palm Beach, FL (US)

Correspondence Address: MCHALE & SLAVIN, P.A., 2855 PGA BLVD, PALM BEACH GARDENS, FL, 33410, US

(21) Appl. No.: 11/030,405

(22) Filed: Jan. 4, 2005

(51) Int. Cl. B28B 1/16; B44F 7/00; B28B 3/00; A47G 35/00

(52) U.S. Cl. 428/15; 264/256; 264/333; 428/542.2

(57) ABSTRACT

A building material made by the method of producing artificial fossil coral which is an artistic replica of a natural coral reef rock by forming a slurry of cement or concrete. Pouring or casting the slurry into a mold of desired shape including driveway sections, walkway sections, patios, or pavers. Broadcasting and impressing into the exposed malleable surface of the cement or concrete a selection of additives with self sustaining shapes including exoskeletons of marine organisms and other debris normally incorporated into natural coral. After the cement or concrete is set-up, the surface is flooded with liquid to dissolve the formed additives leaving voids simulating the surface of natural coral rock.

### FIELD OF THE INVENTION

The present invention is directed to simulated coral rock and a method of producing artificial fossilized coral.

### BACKGROUND OF THE INVENTION

Reefs are tropical ecosystems containing layers of living corals, photosynthetic plants, water polyps and algae. Herbivorous fish, such as butterfly fish, sea urchins, sea cucumbers, brittle stars and numerous species of mollusks feed on the algae. Coral reefs found in tropical waters are formed by an accumulation of calcium containing exoskeletons of such coral animals, the sea shells or remains of the mollusks and fossilized shellfish and fish skeletons. Single celled algae known as zooxanthellae live within the polyps and a skeleton contained filamentous green algae surrounds the polyps. As the coral rock is formed, the exoskeletons of the incorporated animal life may dissolve leaving an imprint of that species in the coral.

In addition to the diversity of life provided by a coral reef, coral reefs are known for their breathtaking beauty. Coral is known for the vivid colors making it a beautiful backdrop to exotic fish. Unfortunely, pollution, ultraviolet radiation, global warning, and excess human interaction have caused the loss of coral to occur at an alarming rate. In fact, due to the high rate of destruction to natural reefs, artificial reefs are now playing an important role in providing shelter, food, protection and spawning areas for hundreds of species of fish and other marine organisms. In fact, an ongoing effort is being made to find materials suitable for the construction of artificial reefs such as tires but may include rocks, ships, planes, cars, heavy-gauge steel structures such as oil platforms and fishing piers.

Thus, while artificial reefs may provide a form of habitat protection, they will never replace the natural beauty of a reef. Unfortunately many in the public realize this and harvest living coral for their own personal enjoyment. This is occurring despite a Florida law that makes it illegal to damage or remove coral.

However, coral rock is much desired and sought after in the building trades as a decorative substitute for materials such as pea gravel, oyster shell, pavers and concrete in walkways, driveways, ground cover for flower beds, patio, deck and other indoor and outdoor uses.

U.S. Pat. No. 6,355,192 to Roth discloses the use of a simulated fossilized coral for display purposes in an aquarium. The simulated coral is made from cement, sand, PVC chips, colorant, rigid sponge or Styrofoam, and fiberglass strands.

Killmer, U.S. Pat. No. 3,773,602, discloses the process of molding a water-extended polyester resin into blocks that closely resembles natural keystone which is a fossilized coral. The only use specifically expressed is in producing decorative objects.

The Cement and Concrete Association of Australia published a brochure teaching the use of rock salt as a finish for concrete or cement to give a weathered look to poured concrete. Other processes for uncovering the aggregate are sandblasting or power washing concrete.

Thus what is lacking in the art is an artificial coral rock that will provide an unlimited source of construction material having the structural and visual characteristics of the naturally occurring fossilized coral.

### SUMMARY OF THE INVENTION

The instant invention is an artificial or artificial fossil coral produced by a method combining cement, sand, aggregate and formed additives which are blended to replicate the fossil rock. Upon placement in the environment of use, the artificial fossil rock provides such a resemblance to the fossilized coral that only an expert can tell the difference.

Thus an objective of the instant invention is to teach a method of making an artificial fossil coral reef rock for use as a construction material.

Another objective of the instant invention is to teach a non-hazardous water resistant structure for use in general construction to simulate fossilized coral, either as large stones, plates, tiles, pavers, or as crushed stone gravel.

A further objective is to teach the use of shell shape imprints to replicate certain reef designs of living coral.

Yet another objection to the instant invention is to provide a simulated fossil reef rock that is so lifelike that it will discourage the use of real fossil reef to help protect the environment.

Other objectives and advantages of this invention will become apparent from the following description wherein are set forth, by way of example, certain embodiments of this invention.

### DESCRIPTION OF THE DRAWINGS:

No Drawings

### DETAILED DESCRIPTION OF THE INVENTION

The instant invention is a construction cement or concrete textured to simulate fossil coral reef rock. The product may be formed from a mixture of cement, sand and water soluble shaped additives. The concrete and cement forms are capable of supporting the loads to which conventional concrete and cement forms are subjected to. In one embodiment of the invention, the cement may be mixed and poured in forms having a desired shape. While the surface portion of the poured cement is still malleable, shaped additives are pressed into the cement. These shaped additives may be in the form of sea shells, fish skeletons, shellfish exoskeletons or other naturally occurring remnants of marine life. Of course, other shapes can be included, such as ship's timbers, carved bowspit, bits of uniforms and shoes, etc. which find their way to the bottom of the ocean. The mix of additives can also include irregular shapes of different sizes which are converted to irregular voids similar to those found in coral rock.

The shaped additives are fashioned from water soluble materials, such as bicarbonate of soda or salt. The size of the shaped additives is selected to best simulate the naturally occurring organisms, from whale bones to the smallest sea shell. The shapes may be coated with a thin water soluble skin, eg., polyvinyl alcohol or carboxymethylcellulose, or other naturally occurring composition, to permit the shapes to be completely seated in the wet cement before beginning to solubilize in the residual water remaining in the cement base.

After the cement has set to a degree that flowing water will not deleteriously affect the surface, the embedded additives are removed by the presence of an excess amount of water. The remaining cement has an irregular surface simulating fossilized coral with the image of the additives inscribed therein.

The same procedure, described above, may be used to finish poured concrete, also. The structural qualities of the concrete or the cement are not affected by this treatment. This allows the cement or concrete to be used conventionally without the added expense of adding a veneer or re-working the surface of the poured block. In the instant procedure, the finish crew broadcasts the shaped additives onto the poured surface and embeds the additives during the finish. Flooding the surface is done later and does not require a skilled crew.

The simulated fossilized coral rock may be poured, on site, as described above, or it may be produced off-site, in various sizes, for installation using masonry techniques.

Further, the finished product may be reduced by a hammer mill or grinder to irregular shapes to be used as an aggregate or by itself. Various colorants may be used in the concrete and cement mixes to simulate the natural hues of the fossilized coral.

It is to be understood that while we have illustrated and described certain forms of our invention, it is not to be limited to the specific forms or arrangement of steps herein described. It will be apparent to those skilled in the art that various changes may be made without departing from the scope of the invention and the invention is not to be considered limited to what is described in the specification.

What is claimed is:

1. A simulated fossilized coral rock product made by the following process:
a) providing a formed cement element by pouring a liquified mass into a mold;
b) allowing said mass to set-up until an exposed surface is malleable;
c) providing a plurality of shaped water soluble additives having shapes imitating exoskeletons of marine organisms;
d) broadcasting said plurality of shaped water soluble additives upon said malleable surface and embedding said plurality of water soluble additives into said malleable surface;
e) permitting said malleable surface to permanently set-up; and
f) flooding the hardened permanently set-up surface with liquid thereby dissolving said plurality of water soluble additives;
whereby a hardened cement construction element is produced simulating fossilized coral rock.

2. A simulated fossilized coral rock product made by the process of claim 1:
a) shaping a quantity of bicarbonate of soda into the self sustaining form of a plurality of marine organisms exoskeletons.

3. A simulated fossilized coral rock product made by the process of claim 1:
a) shaping a quantity of salt into the self sustaining form of a plurality of marine organisms exoskeletons.

4. A simulated fossilized coral rock product made by the process of claim 1:
a) removing said mold; and
b) reducing said hardened cement construction element to irregular smaller shapes.

5. A simulated fossilized coral rock product made by the process of claim 1:
a) providing a formed concrete element by pouring a liquified mass into a mold; and
b) flooding the hardened permanently set-up surface with liquid thereby dissolving said plurality of water soluble additives;
whereby a hardened concrete construction element is produced simulating fossilized coral rock.

6. A simulated fossilized coral rock product made by the process of claim 5:
a) shaping a quantity of bicarbonate of soda into the self sustaining form of a plurality of marine organisms exoskeletons.

7. A simulated fossilized coral rock product made by the process of claim 5:
a) shaping a quantity of salt into the self sustaining form of a plurality of marine organisms exoskeletons.

8. A simulated fossilized coral rock product made by the process of claim 5:
a) removing said mold; and
b) reducing said hardened cement construction element to irregular smaller shapes.

9. A method of producing a simulated fossilized coral rock for construction applications comprising the steps of:
a) providing a formed cement element by pouring a liquified mass into a mold, said mass having an exposed surface;
b) allowing said mass to set-up until said exposed surface is malleable;
c) shaping a plurality of bicarbonate of soda additives into self sustaining shapes;
d) broadcasting said plurality of shaped additives upon said malleable surface and embedding said plurality of water soluble additives into said malleable surface;
e) permitting said malleable surface to permanently set-up; and
f) flooding the hardened permanently set-up surface with liquid thereby dissolving said plurality of water soluble additives;
whereby a hardened cement construction block is produced simulating fossilized coral rock.

10. A method of producing a simulated fossilized coral rock for construction applications of claim 9 comprising the step of:
a) providing a formed concrete element by pouring a liquified mass into a mold, said mass having an exposed surface.
